(19) United States
(12) Patent Application Publication
(10) Pub. No.: US 2026/0339181 A1
(43) Pub. Date: Oct. 29, 2026

(54) STORY PROJECTOR

(71) Applicant: LONVIS TECHNOLOGY (SHENZHEN) CO., LTD., Shenzhen (CN)

(72) Inventor: Xuequan LI, Shenzhen (CN)

(73) Assignee: LONVIS TECHNOLOGY (SHENZHEN) CO., LTD., Shenzhen (CN)

(21) Appl. No.: 19/658,412

(22) Filed: Apr. 24, 2026

(30) Foreign Application Priority Data
Apr. 25, 2025 (CN) 202520808466.8

(51) Int. Cl. G03B 21/00; G03B 21/20; G03B 29/00

(52) U.S. Cl. CPC G03B 21/001; G03B 21/208; G03B 29/00

(57) ABSTRACT

The present disclosure discloses a story projector, including a projection disc, a light source assembly, a lens module, and a control board, the projection disc including a tray bracket, where a projection film and an NFC tag are arranged on the tray bracket; the projection disc is detachably arranged between the light source assembly and the lens module; the control board stores various audio files and the control board is electrically connected to the light source assembly; and the control board is electrically connected to a speaker and an NFC identification board, and the NFC identification board is in signal communication with the NFC tag. The present disclosure has the advantages of low manufacturing cost and immunity to light interference during the identification of a projection disc.

### CROSS-REFERENCE TO RELATED APPLICATIONS

This application claims the priority benefit of Chinese application serial No. 202520808466.8, filed on Apr. 25, 2025, the entirety of which is hereby incorporated by reference herein and made a part of the specification.

### TECHNICAL FIELD

The present disclosure relates to the field of projection devices, in particular to a story projector.

### BACKGROUND OF THE INVENTION

Story projectors are widely used in early childhood education. Images are printed on projection films or transparencies to form projection discs. By means of optical projection, the images are magnified and projected onto walls, screens, or ceilings, so as to create projected scenes from a story, thereby enhancing the intuitiveness and interest of enlightenment teaching.

To further enhance the effect of early childhood education, in the prior art, story projectors often combine images with audios, and plays corresponding audios while performing optical projection. For example, Chinese Patent Application No. CN201420196142.5 discloses a sound-producing rotatable film projector. The sound-producing rotatable film projector integrates a film turntable, identification resistors, a controller, and a card reader, and synchronously plays images and sound files by means of related devices. Consequently, each played image can be paired with a preset sound file, offering convenience for educational or instructional purposes and helping viewers form a strong associative impression and memory between the image and its accompanying sound file. However, the above sound-producing rotatable film projector determines a circuit signal corresponding to a relevant film by identifying a resistance value of an identification resistor arranged on the film turntable and transmits the circuit signal. The card reader automatically determines a sound file corresponding to the circuit signal and transmits the sound file from the memory card to the player for playback. Since the identification resistor needs to be welded onto the film turntable, the difficulty in installation and manufacturing is high. Moreover, during the welding process, if the welding position of the identification resistor is incorrect, the entire film turntable is scrapped, thereby increasing the manufacturing cost.

To reduce the manufacturing cost, Chinese Patent Application No. CN201320345678.4 discloses a card-readable interactive story machine. This machine employs an optical reader to identify cards printed with identification QR code identifiers, so as to obtain various voice trigger signals or actions, and then correspondingly emit sound signals through a voice circuit board. Although the manufacturing cost of the QR code identifiers is low, the above card-readable interactive story machine is incapable of image projection. If the identification resistors of the aforementioned sound-producing rotatable film projector are simply replaced with QR code identifiers, and the brushes cooperating with the identification resistors are replaced with an optical reader, due to the presence of the LED projector, the optical reader would be easily interfered with by the light emitted by the LED projector during projection, thereby reducing the identification accuracy of the optical reader.

How to solve the above difficulty has become a technical problem that needs to be solved urgently.

### SUMMARY

An objective of the present disclosure is to provide a story projector, which has the advantages of low manufacturing cost and immunity to light interference during the identification of a projection disc.

To achieve the above objective, the present disclosure adopts the following technical solution.

A story projector is provided in the present disclosure, including a projection disc, a light source assembly, a lens module, and a control board, the projection disc including a tray bracket, where a projection film and an NFC tag are arranged on the tray bracket; the projection disc is detachably arranged between the light source assembly and the lens module; the control board stores various audio files and the control board is electrically connected to the light source assembly; and the control board is electrically connected to a speaker and an NFC identification board, and the NFC identification board is in signal communication with the NFC tag.

Further, the story projector also includes a power assembly, where the power assembly is electrically connected to the control board, and the power assembly is drivingly connected to the projection disc, to drive the projection disc to rotate about its axis.

Further, the power assembly includes a gear and a motor, where the gear is mounted on an output shaft of the motor and the gear is engaged with the tray bracket, and the motor is electrically connected to the control board.

Further, a plurality of tooth protrusions are arranged circumferentially on an outer peripheral wall of the tray bracket; each of the tooth protrusions meshes with the gear; the tray bracket is provided with a central through hole; the projection film is fixedly received in the central through hole; and a surface of the tray bracket facing the NFC identification board is provided with an annular groove, and the NFC tag is embedded in the annular groove.

Further, the story projector also includes a housing, where the light source assembly, the lens module, the NFC identification board, the speaker, the motor, and the control board are all fixedly arranged within the housing; the projection disc is detachably and rotatably inserted into the housing; and the projection disc is located between the light source assembly and the lens module.

Further, when the projection disc is inserted into the housing, the lens module, the NFC identification board, the projection film, the NFC tag, the tray bracket, and the light source assembly are all coaxial.

Further, the light source assembly includes a lamp board and a reflector cup, where the lamp board is electrically connected to the control board and the lamp board is arranged at the bottom of the reflector cup, and a lens is arranged between the reflector cup and the projection film.

Further, the NFC identification board is of an annular structure, and an inner diameter of the NFC identification board is greater than an outer diameter of the projection film.

Further, the projection film is a transparent projection film.

Due to the adoption of the above structure, the beneficial effects of the present disclosure are as follows:

The present disclosure provides a projection disc which includes a projection film and an NFC tag. Under the illumination of a light source assembly, images printed on the projection film are magnified by a lens module and projected onto walls, screens, or ceilings. Moreover, the projection disc also includes an NFC tag. An NFC identification board can identify information programmed into the NFC tag on each projection disc and send the information to a control board. The control board retrieves a corresponding audio based on the received information and plays the audio through a speaker. Therefore, in the present disclosure, the NFC technology is employed to identify different projection discs, resulting in low manufacturing costs. Furthermore, the information in the NFC tag can be repeatedly programmed for multiple times, and the identification process will not be interfered with by the light emitted by the light source assembly, thereby effectively improving the accuracy of identification.

The present disclosure will become clearer through the following description and in conjunction with the accompanying drawings, and these drawings are intended to explain the embodiments of the present disclosure.

### BRIEF DESCRIPTION OF THE DRAWINGS

To describe the technical solutions in the embodiments of the present disclosure more clearly, the accompanying drawings to be used in the description of the embodiments or the prior art will be briefly introduced below. Apparently, the accompanying drawings in the following description are merely some embodiments of the present disclosure. Other accompanying drawings may also be obtained by those skilled in the art according to these accompanying drawings without any creative effort.

FIG. 1 is an overall structural schematic diagram of the present disclosure.

FIG. 2 is a housing in the prior art.

Reference numerals: lens module—1; NFC identification board—2; projection film—3;

NFC tag—4; tray bracket—5; lens—6; reflector cup—7; lamp board—8; gear—9; motor—10; control board—11; speaker—12.

### DETAILED DESCRIPTION OF THE INVENTION

The technical solutions in the embodiments of the present disclosure will be clearly and completely described below with reference to the accompanying drawings in the embodiments of the present disclosure. Obviously, the described embodiments are only some, but not all of the embodiments of the present disclosure. Based on the embodiments of the present disclosure, all other embodiments obtained by those skilled in the art without any creative effort shall fall within the protection scope of the present disclosure.

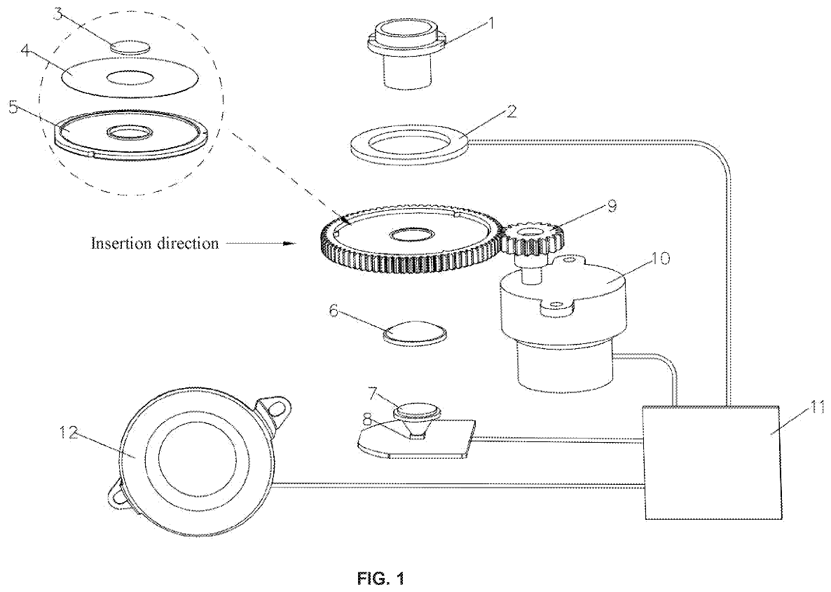

Referring to FIG. 1, the story projector provided in the present disclosure includes a projection disc, a light source assembly, a lens module 1, and a control board 11, the projection disc including a tray bracket 5. A projection film 3 and an NFC tag 4 are arranged on the tray bracket 5. Preferably, the projection film 3 is a transparent projection film. The projection disc is detachably arranged between the light source assembly and the lens module 1, such that the two sides of the projection film 3 correspond to the light source assembly and the lens module 1 respectively. Under the illumination of the light source assembly, images printed on the projection film 3 can be magnified by the lens module 1 and projected onto walls, screens, or ceilings, so as to create projected scenes from a story, thereby enhancing the intuitiveness and interest of enlightenment teaching.

The control board 11 stores various audio files and the control board 11 is electrically connected to the light source assembly. Furthermore, the control board 11 is electrically connected to a speaker 12 and an NFC identification board 2, and the NFC identification board 2 is in signal communication with the NFC tag 4. The NFC identification board 2 identifies information programmed into the NFC tag 4 on different projection discs through signal sensing and sends the information to the control board 11. The control board 11 retrieves a corresponding audio based on the received information and plays the audio through the speaker 12, thereby combining images with audios to improve the teaching effect. Therefore, in the present disclosure, the NFC technology is employed to identify different projection discs, resulting in low manufacturing costs. Furthermore, the information in the NFC tag 4 can be repeatedly programmed for multiple times, and the identification process will not be interfered with by the light emitted by the light source assembly, thereby effectively improving the accuracy of identification.

Specifically, the control board 11 includes a microprocessor (such as an MCU/CPU), a memory electrically connected to the microprocessor (such as a Flash chip for storing audios), and an audio decoding circuit. The memory, the audio decoding circuit, and the NFC identification board 2 are all electrically connected to the microprocessor via I2C or SPI interfaces. The NFC identification board 2 includes a radio frequency chip and a sensing coil. During operation, the NFC identification board 2 uses the sensing coil to sense and identify the information programmed into the NFC tag 4 on different projection discs. The information is received by the radio frequency chip, converted into a digital signal, and then sent to the microprocessor. The microprocessor retrieves a corresponding audio from the memory based on the received digital information, decodes the audio via the audio decoding circuit, and plays the audio through the speaker 12. The above specific structure and function of the control board 11 are common general knowledge in the art. Those skilled in the art can determine it without any doubt by combining common general knowledge, and implement it without additional specific structural details.

In the present disclosure, the story projector also includes a power assembly, where the power assembly is electrically connected to the control board 11, and the power assembly is drivingly connected to the projection disc, to drive the projection disc to rotate about its axis, thereby causing the projected image to rotate. This enhances the visual effect and is capable of attracting the attention of children more effectively. Particularly, when projecting a starry sky scene, the power assembly can simulate the rotation of the galaxy, and provide a superior viewing experience.

In the present disclosure, the power assembly includes a gear 9 and a motor 10, where the gear 9 is mounted on an output shaft of the motor 10 and the gear 9 is engaged with the tray bracket 5, and the motor 10 is electrically connected to the control board 11. The gear 9 is coaxially and fixedly mounted on the output shaft of the motor 10. When the control board 11 activates the motor 10, the output shaft of the motor 10 rotates axially, thereby driving the gear 9 to rotate axially synchronously. This rotation drives the tray bracket 5 engaged with the gear 9 to rotate axially, and further drives the projection film 3 to rotate axially synchronously, thereby causing the projected image to rotate.

In the present disclosure, a plurality of tooth protrusions are arranged circumferentially on an outer peripheral wall of the tray bracket 5; each of the tooth protrusions is engaged with the gear 9, such that the motor 10 can drive the projection disc to rotate about its axis via the gear 9. Moreover, the tray bracket 5 is provided with a central through hole, and the projection film 3 is fixedly received in the central through hole, allowing light emitted by the light source assembly to enter the central through hole and pass through the projection film 3 for projection. Additionally, a surface of the tray bracket 5 facing the NFC identification board 2 is provided with an annular groove, and the NFC tag 4 is embedded in the annular groove.

Preferably, the annular groove is coaxially formed at an outer side of the central through hole, and the tooth protrusions are arranged around the outer side of the annular groove.

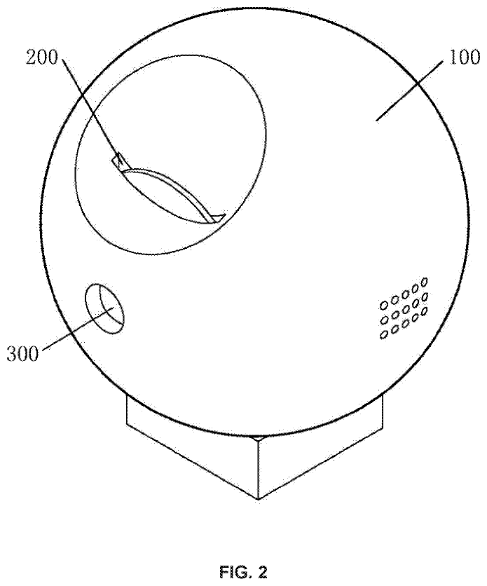

In the present disclosure, the story projector also includes a housing, where the light source assembly, the lens module 1, the NFC identification board 2, the speaker 12, the motor 10, and the control board 11 are all fixedly arranged within the housing; the projection disc is detachably and rotatably inserted into the housing; and the projection disc is located between the light source assembly and the lens module 1. The housing belongs to the prior art and is not the protection focus of the present disclosure. The specific structure of the housing can refer to the housing body in the patent solution of the patent application entitled “Sound-Producing Rotatable Film Projector” with a patent number of CN201420196142.5. The specific structure is shown in FIG. 2, including a housing body 100, where the housing body 100 is approximately spherical. The housing body 100 is provided with a recess, and the recess is provided with a strip-shaped slot 200 for the insertion of the projection disc. The housing body 100 is provided with a projection opening 300 which allows optical images to be projected therethrough.

Preferably, the insertion direction of the projection disc is perpendicular to the axial direction of the gear, thereby effectively ensuring that the tooth protrusions are engaged with the gear 9 when the projection disc is inserted into the housing, making insertion and removal convenient, and providing a high degree of engagement between the tray bracket 5 and the gear 9 after insertion.

Preferably, during use, the projection disc is inserted from top to bottom into the housing body 100 through the strip-shaped slot 200 in the direction of gravity, such that when the motor 10 drives the projection disc to rotate through the gear 9, the tray bracket 5 can maintain a state of meshing with the gear 9 under the action of gravity and the positional restriction provided by the strip-shaped slot 200.

In the present disclosure, when the projection disc is inserted into the housing, the lens module 1, the NFC identification board 2, the projection film 3, the NFC tag 4, the tray bracket 5, and the light source assembly are all coaxial, thereby effectively ensuring that the light emitted by the light source assembly can be projected sequentially through the projection film 3 and the lens module 1, and that the projection disc will not move radially when rotating.

In the present disclosure, the light source assembly includes a lamp board 8 and a reflector cup 7, where the lamp board 8 is electrically connected to the control board 11 and the lamp board 8 is arranged at the bottom of the reflector cup 7, and a lens 6 is arranged between the reflector cup 7 and the projection film 3.

Optionally, the lamp board 8 is an LED lamp board.

In the present disclosure, the NFC identification board 2 is of an annular structure, and an inner diameter of the NFC identification board 2 is greater than an outer diameter of the projection film 3, such that the light emitted by the light source assembly can pass through the center of the NFC identification board 2, thereby effectively preventing the NFC identification board from blocking the projection.

When the present disclosure is in use, a projection disc to be used for projection is inserted into the housing, the lamp board 8 is activated through the control board 11, so the lamp board 8 emits light, and the light sequentially passes through the reflector cup 7, the lens 6, the projection film 3, and the lens module, so as to project images printed on the projection film 3 onto walls, screens, or ceilings. Meanwhile, the NFC identification board 2 can identify information programmed into the NFC tag 4 on the projection disc and send the information to the control board 11. The control board 11 retrieves a corresponding audio based on the received information and plays the audio through the speaker 12, thereby combining images with audios to improve the teaching effect. Furthermore, the motor 10 is activated through the control board 11, and the motor 10 drives the tray bracket 5 to rotate axially through the gear 9, thereby driving the projection film 3 to rotate axially synchronously, causing the projected image to rotate, and effectively enhancing the visual effect. Therefore, in the present disclosure, the NFC technology is employed to identify different projection discs, resulting in low manufacturing costs. Furthermore, the information in the NFC tag 4 can be repeatedly programmed for multiple times, and the NFC identification board 2 is immune to interference from light emitted by the light source assembly when identifying the information programmed into the NFC tag 4, thereby effectively improving the accuracy of identification.

The preferred embodiments of the present disclosure have been described above. It should be understood that the present disclosure is not limited to the specific embodiments described above. The devices and structures not described in detail should be understood to be implemented in ordinary ways in the art. Those skilled in the art can make many possible variations and modifications to the technical solutions of the present disclosure using the methods and technical contents disclosed above without departing from the scope of the technical solutions of the present disclosure, or modify them into equivalent embodiments of equivalent changes, which do not affect the essence of the present disclosure. Therefore, any simple modifications, equivalent changes, and modifications made to the above embodiments based on the technical essence of the present disclosure without departing from the content of the technical solutions of the present disclosure still fall within the protection scope of the technical solutions of the present disclosure.

What is claimed is:

1. A story projector, comprising:
a projection disc, a light source assembly, a lens module (1), and a control board (11), the projection disc comprising a tray bracket (5), wherein a projection film (3) and an NFC tag (4) are arranged on the tray bracket (5); the projection disc is detachably arranged between the light source assembly and the lens module (1); the control board (11) stores various audio files and is electrically connected to the light source assembly; and the control board (11) is electrically connected to a speaker (12) and an NFC identification board (2), and the NFC identification board (2) is in signal communication with the NFC tag 2. The story projector according to claim 1, further comprising:
a power assembly, electrically connected to the control board (11), and the power assembly is drivingly connected to the projection disc, to drive the projection disc to rotate about its axis.

3. The story projector according to claim 2, wherein:
the power assembly comprises a gear (9) and a motor (10), wherein the gear (9) is mounted on an output shaft of the motor (10) and the gear (9) is engaged with the tray bracket (5), and the motor (10) is electrically connected to the control board (11).

4. The story projector according to claim 3, wherein:
a plurality of tooth protrusions are arranged circumferentially on an outer peripheral wall of the tray bracket (5); each of the tooth protrusions is engaged with the gear (9); the tray bracket (5) is provided with a central through hole; the projection film (3) is fixedly received in the central through hole; and a surface of the tray bracket (5) facing the NFC identification board (2) is provided with an annular groove, and the NFC tag (4) is embedded in the annular groove.

5. The story projector according to claim 1, wherein:
the light source assembly comprises a lamp board (8) and a reflector cup (7), wherein the lamp board (8) is electrically connected to the control board (11) and the lamp board (8) is arranged at the bottom of the reflector cup (7); and a lens (6) is arranged between the reflector cup (7) and the projection film (3).

6. The story projector according to claim 1, wherein:
the NFC identification board (2) is of an annular structure, and an inner diameter of the NFC identification board (2) is greater than an outer diameter of the projection film (3).

7. The story projector according to claim 1, wherein:
the projection film (3) is a transparent projection film.
